(19) United States
(12) Patent Application Publication
(10) Pub. No.: US 2006/0022895 A1
(43) Pub. Date: Feb. 2, 2006

(54) Remote control unit with memory interface

(76) Inventors: David A. Williams, Corvallis, OR (US); John G. Campbell, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/901,571

(22) Filed: Jul. 28, 2004

(51) Int. Cl. G09G 5/00

(52) U.S. Cl. 345/2.1

(57) ABSTRACT

A remote control unit configured to operate a display device, where the remote control unit includes onboard memory, an interface configured to connect with an independent memory device, and a processor configured to transfer image data from the independent memory device to the onboard memory via the interface.

### BACKGROUND

Display systems may be used to display still or video images, or to enable an image to be viewed simultaneously by a large or small audience. Such display systems have become extremely popular. However, methods for transferring images to the display system may be cumbersome, expensive, and/or inaccessible. In particular, there is demand for a display systems that readily and conveniently accept digital image files for subsequent display, regardless of the skill level of the operator, or the physical accessibility of the display device.

### BRIEF DESCRIPTION OF THE DRAWINGS

FIG. 1 is a schematic depiction of a display system according to an embodiment of the invention.

FIG. 2 is an isometric view of a remote control unit according to an embodiment of the invention.

FIG. 3 is a flowchart depicting a method of transferring image data to a display device, according to an embodiment of the invention.

### DETAILED DESCRIPTION

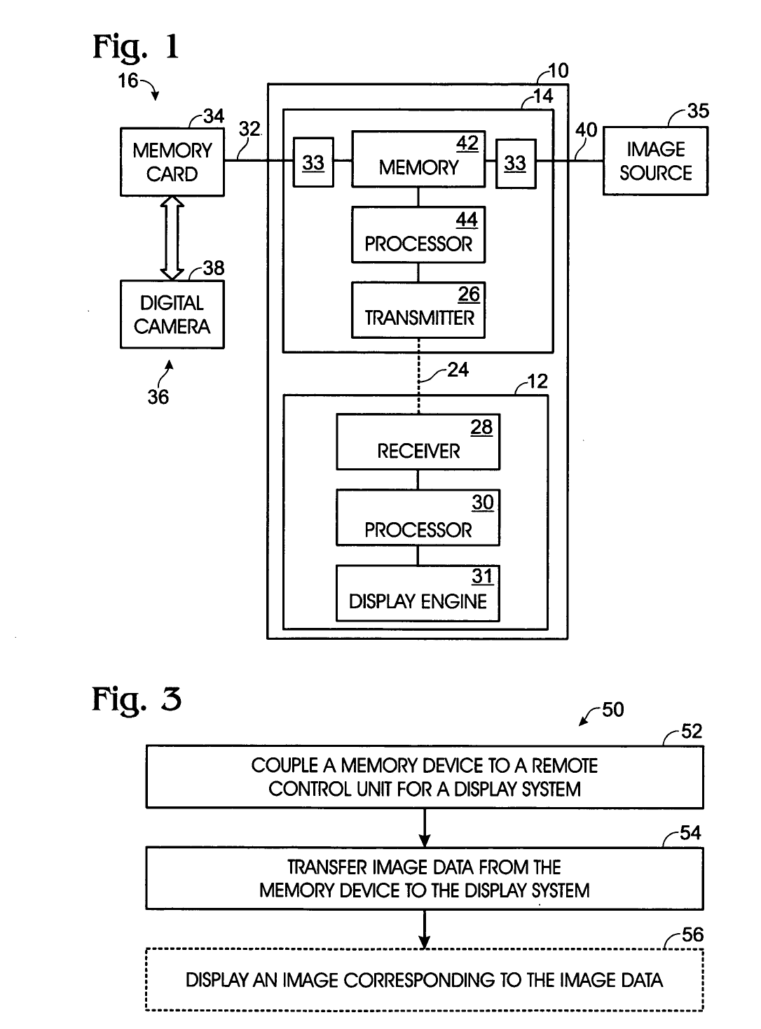

Referring initially to FIG. 1, a representative display system is shown generally at 10. The display system may include a display device 12 and a remote control unit 14 configured to direct operation of the display device. Remote control unit 14 may be configured to effect transfer of image data from an independent memory device 16 to display device 12.

Display device 12 may be useful in displaying any of a variety of still or moving images, while remote control unit 14 may be configured to direct operation of display device 12. The display device may take various forms, including, for example, a digital projector, a front-projection display, a rear-projection display, an LCD display, a plasma display, a cathode ray tube display, among others. In particular, the display device may be mounted or used in a location that is inaccessible to an operator, such as where the display device is a ceiling-mounted projector, or a projector mounted within a wall or cabinet.

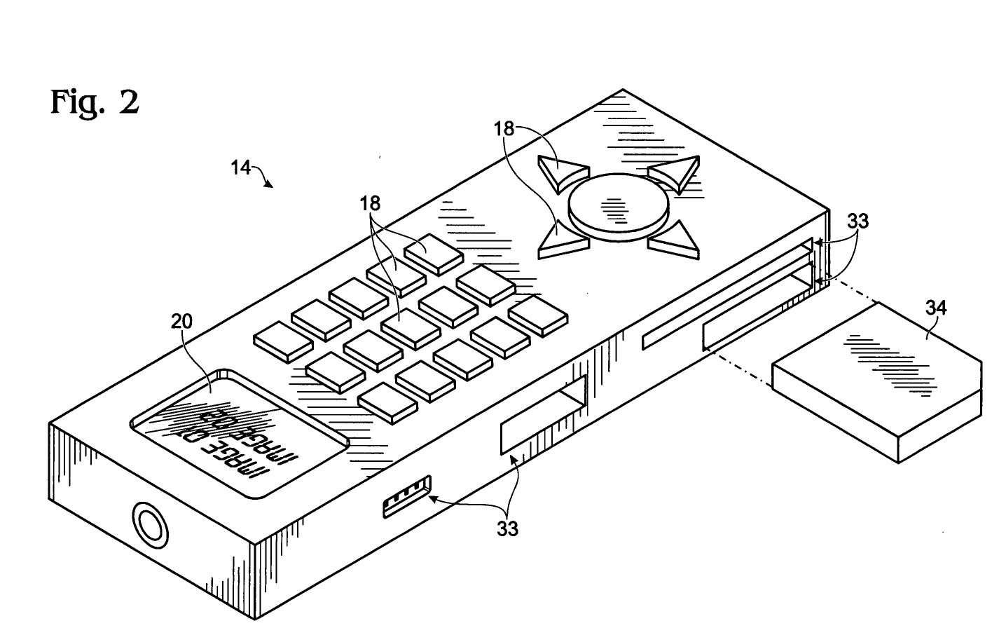

An exemplary remote control unit 14 is depicted in FIG. 2. Remote control unit 14 may include one or more control inputs 18 for changing one or more operating parameters of the display device. In the present illustration, such inputs take the form of keypad buttons, but the control inputs may take the form of dials, toggles, sliders, or any other appropriate input method. The remote control unit also may include a display 20 to permit an operator to view display device settings, or to offer a menu-driven input system, for example, in cooperation with a control input such as a joystick or other selection device.

The control inputs may control, among other display device operating parameters, power to the display device, display brightness, display focus, and display color balance. Alternatively, or in addition, the control inputs may be adapted for selecting from among a plurality of image sources of still or video images 22. Such image sources may include, for example, DVD readers, videotape players, satellite video signal sources, cable television signal sources, broadcast television signal sources, digital image file sources, among others. The control inputs also may be employed to adjust the volume of an internal or external audio source, or to control a display device, an image source, or both.

Image data may be transmitted from the remote control unit to the display device via any suitable wireless transmission method, indicated by dashed line 24 in FIG. 1. Appropriate wireless transmission methods include infrared beam modulation, radio wave transmission, among others. The transmission method may be the same as, or distinct from, the wireless transmission method used to operate the display device with the remote control device. Any suitable protocol for wireless data transfer may be used, including for example Bluetooth, Shared Wireless Access Protocol (SWAP), or IrDA. The remote control unit may include an appropriate transmitter 26 for such wireless transfer method, and the display device may include a correspondingly appropriate receiver 28. The remote control unit may be configured to receive information from the display device as well. For example, the remote control unit may be configured to receive a confirmation signal that a given image has been received satisfactorily. Alternatively, or additionally, information regarding the status of the display device may be received.

The display device typically includes a receiver that is configured to receive the transmitted image data and may further be configured to convert received image data into a format suitable for display. For example, the display device may include a processor 30 configured to convert the received image data into a corresponding set of display engine commands for execution by a display engine 31 of the display device. The display engine thus may render the desired image on the display.

Remote control unit 14 may be configured to effect transfer of image data from an independent memory device 16 to display device 12. The remote control unit 14 may therefore be adapted to permit electronic connection with independent memory device 16, that is, the remote control unit and the memory device may be electronically connected in such a fashion as to permit one or more image data files to be transferred between independent memory device 16 and onboard memory 42 of remote control unit 14. Any type of connection, such as a physical connection or wireless connection, that permits image data transfer is a suitable connection. The memory device and the remote control unit may be physically connected via an interface 32, such as a port, socket, or cable connection. The remote control unit may include a plurality of interfaces, permitting several distinct memory devices to be interfaced with the remote control unit, either simultaneously or sequentially.

Interface 32 may include a physical port 33 that may be configured to be complementary to a particular memory device or connector, that is, the interface port may have an appropriate shape and size such that the desired memory device may be inserted into, mated with, and/or tethered to the remote control unit to enable image data transfer. Appropriate interfaces may include USB sockets, ethernet ports, or other connections that facilitate the transfer of image data.

Independent memory device 16 may include a portable memory storage medium 34, such as a mechanical microdrive, SD memory card, compact flash memory card, memory stick, multimedia card, or the like. The portable memory device may include a controller chip to facilitate storage, receipt, and/or transfer of image data. The memory device typically is configured to physically connect to the remote control unit via interface 32. The memory device additionally may be configured to physically connect to an additional image data source 36, such as a digital camera or computer system.

For example, the memory device may be a memory card, where the memory card is used in conjunction with a digital camera 38. Digital images obtained using the camera may be stored on the memory card, which may be removed from the camera and connected to the remote control unit via the appropriate interface 32. The digital images may then be transferred to the display device.

Alternatively, the memory device may include an independent image data sources 35 such as a personal digital assistant (PDA), a digital camera, or a laptop computer. The remote control unit may accept digital image data directly from such an independent image data source via an interface that includes an intermediate connecter 40, such as a data cable, without requiring intermediate portable memory storage. The remote control unit thus may be transported to and interfaced with an image data source, image data may be transferred to the remote control unit, and the remote control unit may then be returned to proximity with the display device in order to facilitate transfer of the image data to the display device. For example, the remote control unit may be connected to a personal computer, and the desired digital images may be transferred to the remote control unit. The remote control unit may then be used to transfer the image data to the display device.

The remote control unit may transmit image data directly from the memory device to the display device. Alternatively, the image data may be stored in onboard memory 42 of the remote control unit, and transmitted to the display device at a subsequent time. The original image data may remain in memory device 16, or the image data may be deleted from the memory device upon transfer. Typically, memory 42 also contains software instructions useful for operating the remote control unit, in conjunction with the remote control processor 44.

Image data, as used herein, typically refers to data in an electronic format that includes graphical content. That is, data that is interpretable to render an image. The image data may include any of a variety of known image data formats, including for example gif, jpeg, tif, bmp, and other image formats, including conversions to or from other document formats, such as for example conversion from a Microsoft PowerPoint file. Alternatively, or in addition, the image data may include data in the format of a video data, such as mpeg, avi, mov, or other video data formats. However, image data, as used herein, may further include any information that is suitable for communication to a display device to effect corresponding display of an image or images by the display device. For example, where a digital file is transferred to a display device that includes a digital projector and thereby projected, the file may be considered image data for the purposes of this disclosure.

As noted, the remote control unit may be further configured to transmit image data to the display device so that the display device may subsequently generate a displayed image corresponding to the received image data. The image data may be transmitted substantially unchanged, or the image data may be transformed, reformatted, compressed, or optimized before transmission to the display device. For example, it may be advantageous for the image data to be converted into pixel data, or another data format that may be interpreted by a display engine to generate a corresponding displayed image. Alternatively, the image data may be transformed, reformatted, compressed, optimized, or otherwise altered after receipt by the display device.

The image data for one or more images may be transmitted from the remote control unit to the display device prior to the display of any of the corresponding images by the display device. Alternatively, the image data for a particular image may be transmitted from the remote control unit on demand, and immediately prior to displaying the corresponding image. In one example, the display of images corresponding to image data resident on either the independent memory device or in the memory of the remote control unit is controlled by the remote control unit itself, so that particular image data is transmitted in real time, that is, the image data is transmitted in response to a command to display the corresponding image on the display device.

The display system described herein may be used to transfer image data to a display device, as described above, and as set out in flowchart 50 of FIG. 3. The illustrated method includes coupling a memory device to a remote control unit for a display system at 52, and transferring image data from the memory device to the display system at 54. The illustrated method may further include displaying an image corresponding to the image data at 56 of flowchart 50.

The step of transferring image data from the memory device to the display system may occur directly, or may include transferring the image data first to the remote control unit and subsequently transmitting the image data from the remote control unit to the display system.

Coupling the memory device to the remote control unit may include inserting the memory device into a complementary port present on the remote control unit, or may include establishing an intermediate connection, such as a data cable, between the memory device and the remote control unit.

Transmitting the image data to the display system may include transmitting the image data in a wireless fashion, such as by modulating an infrared or radio wave signal.

The memory device may be compatible with a digital camera, and thus may be configured to read digital images in a data format used by the digital camera. In this manner, digital images captured by a digital camera may be saved on a memory card, and the memory card may be removed from the digital camera and connected to the remote control unit by inserting the memory card into an appropriate port. The captured digital images may then be transferred to the remote control unit, and transmitted to the display system, for subsequent display of the images. The data may be transmitted by encoding the data via modulation of an infrared or radio wave signal.

The display device may be configured to display the images corresponding to the received image data either automatically or upon activation of an appropriate display function by the operator. For example, a series of digital images saved on the memory device may be transmitted to the display device and then displayed sequentially, for example as a slide show.

The display system described herein permits the rapid and easy transfer of images to a display system, even where the display device is inaccessible, as in the case of a projector mounted within a ceiling or wall, or where an access point may be unreachable. In this manner, digital images may be readily viewed and enjoyed by larger audiences, without specialized equipment or knowledge.

While various alternative embodiments and arrangements of the remote control unit, the display system, and the method for transferring image data to the display system have been shown and described above, it will be appreciated by those of skill in the art that numerous other embodiments, arrangements, and modifications are possible and are within the scope of the present disclosure. Those skilled in the art thus will understand that many variations may be made therein without departing from the spirit and scope as defined in the following claims. The present description should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring, nor excluding two or more such elements.

What is claimed is:

1. A remote control unit configured to operate a display device, comprising:
onboard memory;
an interface adapted to connect with an independent memory device; and
a processor configured to transfer image data from the independent memory device to the onboard memory via the interface.

2. The remote control unit of claim 1, further comprising a transmitter configured to transmit the image data from the onboard memory to the display device.

3. The remote control unit of claim 2, wherein the processor is further configured to convert the image data into a corresponding set of display engine commands for transmission to the display device.

4. The remote control unit of claim 1, wherein the independent memory device is a portable memory device that is connected to the remote control unit via insertion into the interface.

5. The remote control unit of claim 1, wherein the memory device is a connected to the remote control unit via an intermediate connector.

6. A display system, comprising:
a display device; and
a remote control unit configured to operate the display device remotely, wherein the remote control unit includes an interface configured to couple with an independent memory device;
wherein the remote control unit is configured to receive image data from the memory device, and transmit the received image data to the display device.

7. The display system of claim 6, wherein the display device is configured to display an image corresponding to the image data transmitted from the remote control unit.

8. The display system of claim 6, wherein the remote control unit is further configured to transfer image data to the independent memory device.

9. The display system of claim 6, wherein the remote control unit is configured to transmit the received image data to the display device via at least one of infrared modulation or radio wave modulation.

10. The display system of claim 9, wherein the infrared or radio wave modulation is compatible with Bluetooth, Shared Wireless Access Protocol (SWAP), or IrDA standards.

11. The display system of claim 6, wherein the interface is configured to couple to an independent memory device that is compatible with a digital camera.

12. A display system, comprising:
a display device; and
a remote control unit configured to operate the display device remotely, wherein the remote control unit includes an interface configured to receive a portable memory device, and the portable memory device is compatible with a digital camera;
wherein the remote control unit is configured to receive image data from the portable memory device, and transmit the received image data to the display device.

13. The display system of claim 12, wherein the display device is inaccessible to an operator.

14. The display system of claim 13, wherein the display device is a ceiling-mounted projector.

15. A method of transferring image data to a display device, comprising:
coupling an independent memory device to a remote control unit of a display system;
transferring image data from the independent memory device to the display device.

16. The method of claim 15, wherein transferring image data from the independent memory device to the display device includes transferring the image data to the remote control unit, and transmitting the image data from the remote control unit to the display system.

17. The method of claim 16, wherein the image data is transmitted from the remote control unit to the display system in response to a command to display a corresponding image using the display device.

18. The method of claim 15, further comprising displaying an image corresponding to the image data.

19. The method of claim 15, wherein coupling the memory device to the remote control unit includes inserting the independent memory device into a complementary port on the remote control unit.

20. The method of claim 15, wherein coupling the memory device to the remote control unit includes establishing an intermediate connection between the independent memory device and the remote control unit.

21. The method of claim 20, wherein the intermediate connection includes a data cable.

22. The method of claim 15, wherein transmitting the image data to the display system includes modulating at least one of an infrared signal or radio wave signal.

23. The method of claim 15, further comprising removing the independent memory device from a digital camera before coupling the independent memory device to the remote control unit.

24. A method of displaying images from a digital camera, comprising:
creating a digital image file with a digital camera;
saving the digital image file to an independent memory device;
coupling the independent memory device to a remote control unit of a display system;
transferring the digital image file from the independent memory device to the display system;
displaying an image corresponding to the digital image file using the display system.

25. A remote control unit, comprising:
a structure configured to be held in a hand, that includes means for exchanging image data with an independent memory device; and means for transferring the image data to a display device.
